(19) United States
(12) Patent Application Publication
(10) Pub. No.: US 2017/0063660 A1
(43) Pub. Date: Mar. 2, 2017

(54) APPLICATION-SPECIFIC INTEGRATED CIRCUIT DATA FLOW ENTITY COUNTING

(71) Applicant: Hewlett Packard Enterprise Development LP, Houston, TX (US)

(72) Inventors: Claudio Enrique Viquez, San Jose (CR); Pedro Elias Alpizar, San Jose (CR)

(21) Appl. No.: 14/837,533

(22) Filed: Aug. 27, 2015

(51) Int. Cl. H04L 12/26; H04L 12/861; H04L 12/859; H04L 12/851; H04L 12/721; H04L 12/725

(52) U.S. Cl. CPC H04L 43/0876; H04L 45/38; H04L 45/306; H04L 47/2475; H04L 47/2483; H04L 49/90

(57) ABSTRACT

In some examples, a network switch includes a switch processing resource and a switch memory resource. The switch memory resource includes machine readable instructions to process a received data packet and to forward the received data packets to another device in a network. The switch further includes a programmable Application-Specific Integrated Circuit (ASIC) that includes an ASIC processing resource and an ASIC memory resource. The ASIC memory resource includes machine readable instructions to manage a plurality of flow entities stored on the memory resource and to count, with a single counter, data relating to data packets that match multiple flow entities of the plurality of flow entities.

### BACKGROUND

Computer networks can be used to allow networked devices, such as personal computers, servers, and data storage devices to exchange data. Computer networks often include intermediary datapath devices such as network switches, gateways, and routers, to flow traffic along selected datapaths for routing data between networked devices. Certain intermediary datapath devices can process data received by the device by modifying metadata information of the data or by copying the data.

### BRIEF DESCRIPTION OF DRAWINGS

FIG. 1 is a diagram of a network, according to an example.

FIG. 2 is a flowchart for a method, according to an example.

FIG. 3 is a diagram of network switch, according to an example.

FIG. 4 is a diagram of machine-readable storage medium, according to an example.

### DETAILED DESCRIPTION

The following discussion is directed to various examples of the disclosure. Although one or more of these examples may be preferred, the examples disclosed herein should not be interpreted, or otherwise used, as limiting the scope of the disclosure, including the claims. In addition, the following description has broad application, and the discussion of any example is meant only to be descriptive of that example, and not intended to intimate that the scope of the disclosure, including the claims, is limited to that example. Throughout the present disclosure, the terms “a” and “an” are intended to denote at least one of a particular element. In addition, as used herein, the term “includes” means includes but not limited to, the term “including” means including but not limited to. The term “based on” means based at least in part on.

Software-defined networking can allow for the decoupling of traffic routing control decisions from the network's physical infrastructure. For example, in a Software-Defined Network (SDN), such traffic routing control decisions (e.g., which port of a network switch should be used to forward traffic en route to a given destination) can be determined by an entity (e.g., a network controller) that is different from the routing device itself (e.g., the network switch tasked with forwarding the traffic). A network controller used in implementing an SDN (i.e., an SDN controller) can, for example, be programmed to: (1) receive dynamic parameters of the network from intermediary datapath devices (e.g., network switches), (2) decide how to route packets over the network, and (3) inform the devices about these decisions.

In certain SDN protocols, such as the OpenFlow protocol, SDN applications (such as SDN security applications, SDN optimization applications, etc.) running on an SDN controller or another device in communication with the SDN controller can instruct the SDN controller to query SDN-capable intermediary datapath devices (such as SDN switches) to collect statistic information such as counters per flow table, per flow entry, per queue, etc. In certain situations, the SDN application may request information relating to the use of multiple flow entities, such as for example how many packets have been sent to either a first given flow table or a second given flow table. In such situations, the SDN controller will collect the information from the SDN devices, do certain operations and provide the result to the SDN applications. If multiple counters are to be queried, then multiple transactions are conducted between the SDN controller and the SDN device. Certain implementations of the present disclosure can be used to improve upon such techniques by providing a flexible mechanism of associating packet/byte counters or meters to multiple SDN entities such as flow tables and flow entries. For example, certain implementations of the present disclosure can leverage a programmable Application Specific Integrated Circuit (ASIC) of a network switch to improve statistics information of SDN pipelines by abstracting a counter entity and associating this entity to multiple flows or tables of an SDN pipeline running in a switch. Other advantages of implementations presented herein will be apparent upon review of the description and figures.

In one implementation, a method, which can for example be implemented by a network switch includes: (1) receiving, from an SDN controller, instructions to associate a first flow entity with a counter of a programmable ASIC and to associate a second flow entity with the same counter; (2) receiving a first data packet having metadata corresponding to the first flow entity; (3) counting, with the counter, data relating to the first data packet in accordance with the association instructions received from the SDN controller; (4) receiving a second data packet having metadata corresponding to the second flow entity; (5) counting, with the counter, data relating to the second data packet in accordance with the association instructions received from the SDN controller; and (6) transmitting, to the SDN controller, data relating to the first and second received data packets.

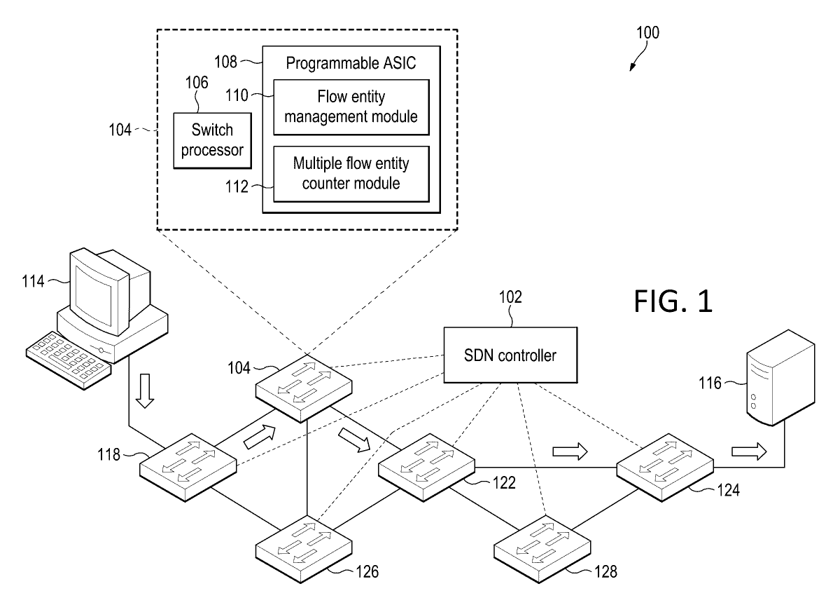

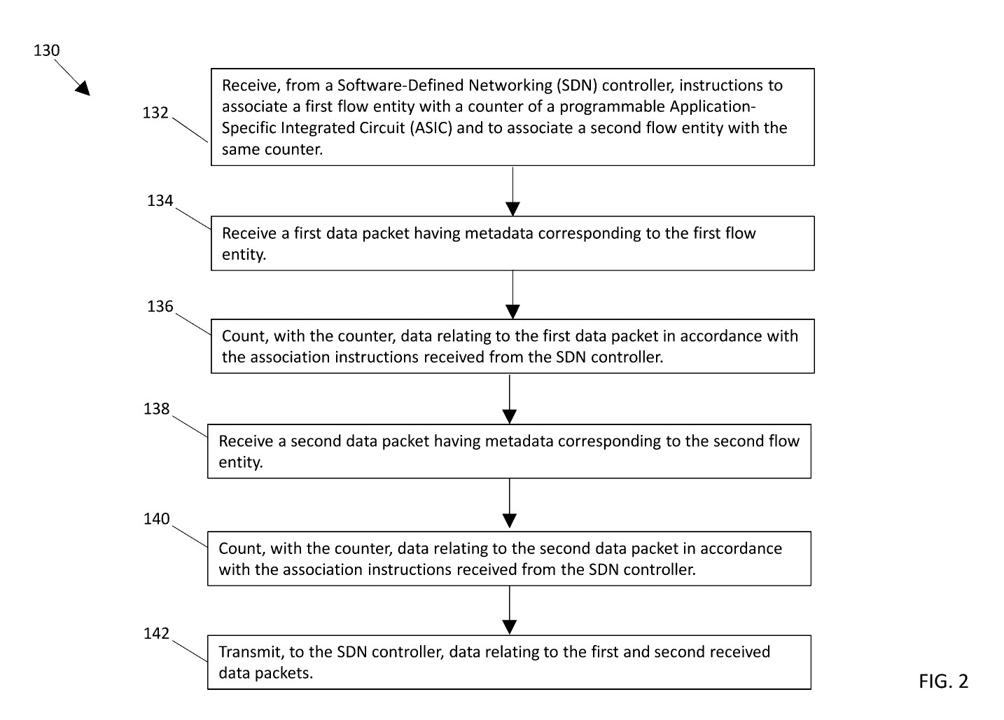

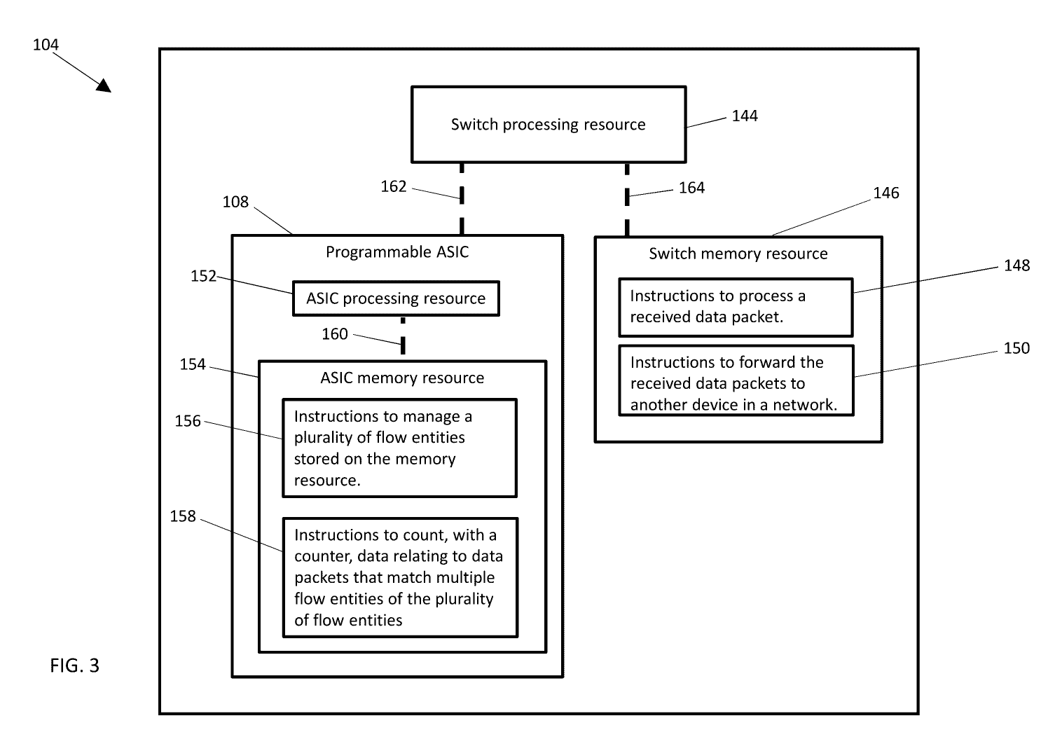

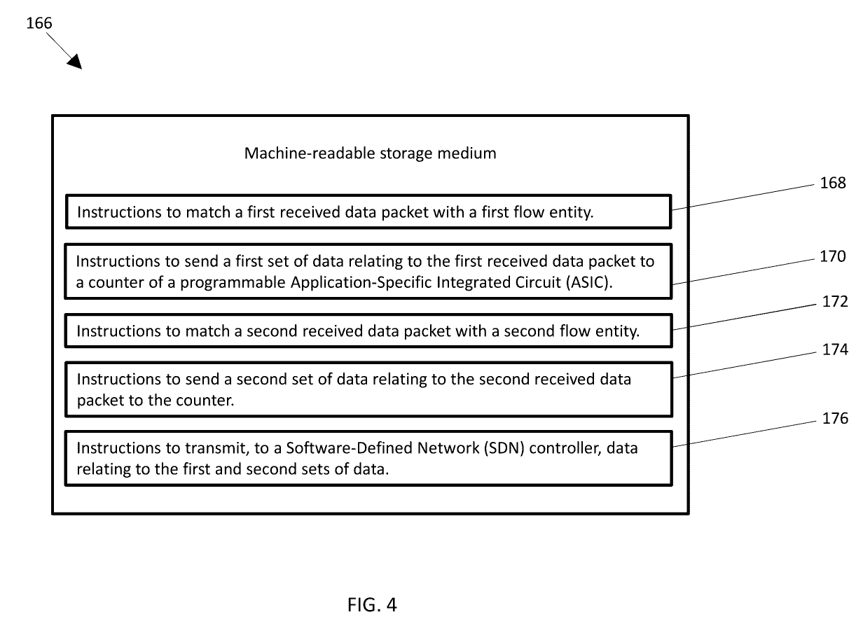

FIG. 1 is a diagram of an example SDN 100 including an example SDN controller 102 as well as an example network switch 104 including (among other components) a switch processor 106 in communication with a programmable ASIC 108 having various combined hardware/software modules 110 and 112. Further details regarding the structure and functionality of network switch 104 are provided below with respect to the method FIG. 2, the switch of FIG. 3, the medium of FIG. 4, and other implementations described herein.

FIG. 1 depicts traffic along a datapath between an example source node 114 and example destination node 116, the datapath being defined by network nodes 118, 104, 122, and 124. Other network nodes, such as nodes 126 and 128 can be included within SDN 100 but are not used in this datapath. It is appreciated that the datapath can be determined by SDN controller 102 based on one or more static parameters, such as link speeds and number of hops between the nodes and can further (or alternatively) be based on one or more dynamic parameters, such as Quality of Service (QoS), network latency, network throughput, network power consumption, etc.

As provided above, network nodes within SDN 100 can forward traffic along the datapath based on metadata within the traffic. For example, traffic in the form of a packet can be received at network switch 104 (or another suitable intermediary network node). For consistency, the industry term “packet” is used throughout this description, however, it is appreciated that the term “packet” as used herein can refer to any suitable protocol data unit (PDU). Such a packet can, for example, include payload data as well as metadata in the form of control data. Control data can, for example, provide data to assist the network node with reliably delivering the payload data. For example, control data can include network addresses for source node 114 and destination node 116, error detection codes, sequencing information, packet size of the packet, a time-to-live (TTL) value, etc. In contrast, payload data can include data carried on behalf of an application for use by source node 114 and destination node 116.

As provided above, in an SDN (such as for example SDN 100), control decisions for routing traffic through the network can be decoupled from the network's physical infrastructure. For example, SDN controller 102 can be used to instruct network nodes to flow traffic along a selected routing path defined by the nodes. In some implementations, these nodes can, for example, be in the form of network switches or other intermediary network devices. The use of such software-defined networking can provide other functionality. For example, one or more SDN applications can be installed on or interface with SDN controller 102 to meet customer use cases, such as to achieve a desired throughput (or another QoS) over SDN 100, enforce security provisions for SDN 100, provide SDN optimization, provide SDN visualization, network tapping, network monitoring, management, deep packet inspection, and/or provide another suitable service or functionality.

The functionality of SDN controller 102 can, for example, be implemented in part via a software program on a standalone machine, such as a standalone server. In some implementations, SDN controller 102 can be implemented on multi-purpose machines, such as a suitable desktop computer, laptop, tablet, or the like. In some implementations, SDN controller 102 can be implemented on a suitable non-host network node, such as certain types of network switches. It is appreciated that the functionality of SDN controller 102 may be split among multiple controllers or other devices. For example, SDN 100 is described and illustrated as including only one SDN controller 102. However, it is appreciated that the disclosure herein can be implemented in SDNs with multiple controllers. For example, in some SDNs, network devices are in communication with multiple controllers such that control of the network can be smoothly handed over from a first controller to a second controller if a first controller fails or is otherwise out of operation. As another example, multiple controllers can work together to concurrently control certain SDNs. In such SDNs, a first controller can, for example, control certain network devices while a second controller can control other network devices. In view of the above, reference in this application to a single SDN controller 102 that controls the operation of SDN 100 is intended to include such multiple controller configurations (and other suitable multiple controller configurations).

Source node 114 and destination node 116 can, for example, be in the form of network hosts or other types of network nodes. For example, one or both of source node 114 and destination node 116 can be in the form of suitable servers, desktop computers, laptops, printers, etc. As but one example, source node 114 can be in the form of a desktop computer including a monitor for presenting information to an operator and a keyboard and mouse for receiving input from an operator, and destination node 116 can be in the form of a standalone storage server appliance. It is appreciated that source node 114 and destination node 116 can be endpoint nodes on SDN 100, intermediate nodes between endpoint nodes, or positioned at other logical or physical locations within SDN 100.

The various intermediary nodes within SDN 100 can, for example, be in the form of switches or other multi-port network bridges that process and forward data at the data link layer. In some implementations, one or more of the nodes can be in the form of multilayer switches that operate at multiple layers of the Open Systems Connection (OSI) model (e.g., the data link and network layers). Although the term “network switch” is used throughout this description, it is appreciated that this term can refer broadly to other types of suitable network data forwarding devices. For example, a general purpose computer can include suitable hardware and machine-readable instructions that allow the computer to function as a network switch. It is appreciated that the term “switch” can include other network datapath elements in the form of suitable routers, gateways and other devices that provide switch-like functionality for SDN 100.

The various nodes within SDN 100 are connected via one or more data channels, which can, for example be in the form of data cables or wireless data channels. Although a single link (i.e., a single line in FIG. 1) between each network node is illustrated, it is appreciated that each single link may include multiple wires or other wired or wireless data channels. Moreover, FIG. 1 further depicts SDN controller 102 as being connected to each network nodes via broken lines, which is intended to illustrate control channels between SDN controller 102 and respective nodes. However, it is appreciated that SDN controller 102 may be directly connected to only one or a few network nodes, while being indirectly connected to other nodes of SDN 100. As but one example, SDN controller 102 can be directly connected to node 122 via an Ethernet cable, while being indirectly connected to node 104 (e.g., by relying on node 122 as an intermediary for communication with node 104).

Within the context of an SDN, such as SDN 100, controlled network nodes can be used as sensors in the network as they have information about dynamic network parameters. When polled via standard SDN interfaces the devices can report this information to the SDN controller. SDN 100 can, for example, be implemented through the use of SDN controller 102 that interfaces with various SDN-compatible devices via a suitable Application Program Interface (“API”), or another suitable protocol (e.g., OpenFlow). In some implementations, SDN controller 102 may interface with controlled network devices via an interface channel that connects each controlled device to SDN controller 102 to allow SDN controller 102 to configure and manage each device, receive events from each device, and send packets using each device.

As used herein, the term “controlled” and similar terminology in the context of SDN-compatible network nodes, such as “controlled switches,” is intended to include devices within the control domain of SDN controller 102 or otherwise controllable by SDN controller 102. Such a controlled node can, for example, communicate with SDN controller 102 and SDN controller 102 is able to manage the node in accordance with an SDN protocol, such as the OpenFlow protocol. For example, an OpenFlow-compatible switch controlled by SDN controller 102 can permit SDN controller 102 to add, update, and delete flow entries in flow tables of the switch using suitable SDN commands.

In the example SDN 100 depicted in FIG. 1, the various network nodes are in the form of intermediary nodes (e.g., controlled network switch 104) and host devices (source node 114 and destination node 116). It is appreciated however, that the implementations described herein can be used or adapted for networks including more or fewer devices, different types of devices, and different network arrangements. It is further appreciated that the disclosure herein can apply to suitable SDNs (e.g., certain hybrid or heterogeneous SDNs) in which some devices are controlled by an SDN controller (e.g., SDN controller 102) and some devices are not controlled by the SDN controller (e.g., SDN controller 102 or any other SDN controller 102). For example, in some implementations, at least one node (e.g., node 104) along a given datapath is controlled by SDN controller 102 and at least one node along the given datapath (e.g., node 122) is not controlled by SDN controller 102.

FIG. 2 illustrates a flowchart for a method 130 according to an example of the present disclosure. For illustration, the description of method 130 and its component blocks make reference to example SDN 100 and elements thereof, such as for example SDN controller 102, network switch 104, etc., however, it is appreciated that method 130 or aspects thereof can be used or otherwise applicable for any suitable network or network element expressly described herein or otherwise. For example, method 130 can be applied to computer networks with different network topologies than those illustrated in FIG. 1.

In some implementations, method 130 can be implemented or otherwise executed through the use of executable instructions stored on a memory resource (e.g., the memory resource of the network switch of FIG. 3), executable machine readable instructions stored on a storage medium (e.g., the medium of FIG. 4), in the form of electronic circuitry (e.g., on an Application-Specific Integrated Circuit (ASIC)), and/or another suitable form. Although the description of method 130 herein primarily refers to steps performed on network switch 104 for purposes of illustration, it is appreciated that in some implementations, method 130 can be executed on another computing device within SDN 100 or in data communication with network switch 104.

Method 130 includes receiving (at block 132), at switch 104 from SDN controller 102, instructions to associate a first flow entity with a counter of ASIC 108 and to associate a second flow entity with the same counter. As used herein, the term “flow entity” is intended to refer broadly to flow-related criteria of switch 104, such as flow tables, flow entries, meter entries, group entries, flow queues, etc.

The instructions of block 132 can, for example, include reserving a counter of ASIC 108 and creating a pointer to the counter such that when a packet matches a flow entity, the counter is triggered via the pointer. As a more specific example, SDN managing software running in a central processing unit (CPU) or other processing resource of ASIC 108 can reserve one of several available counters stored on ASIC 108 and create a pointer to the reserved counter. When a flow entity, such as a flow table, flow entry, or flow queue, is eventually created in the hardware of ASIC 108, the created flow entity is associated with a pointer to the counter that was previously allocated.

As used herein, the term “counter” is intended to refer to any suitable tool for recording data related to network traffic. For example, in some implementations, the counter can count a number of packets that trigger the counter (e.g., packets that match criteria for a flow entry), and/or an amount of bytes of packets that trigger the counter. As provided above, the term “counter” is further intended to cover meter-type counters that can, for example, be used to obtain a rate relating to received data packets.

Method 130 includes receiving (at block 134) at switch 104 a first data packet having metadata corresponding to the first flow entity. A data packet can, for example, “correspond” to a flow entity because it contains metadata fields that match the flow entity. An example is provided in which flow rules are used as flow entities for illustration. Such flow rules can, for example, contain information such as: (1) match fields to match against packets (e.g., an ingress port and specific packet header fields), (2) a priority value for the flow rule to allow prioritization over other flow entries, (3) counters that are updated when packets are matched, (4) instructions to modify the action set or pipeline processing, (5) timeouts indicating a maximum amount of time or idle time before a flow is expired by the switch, and (6) a cookie value which can be used by SDN controller 102 to filter flow statistics, flow modification, and flow deletion. In such an example, a packet may include one or more metadata fields, such as a given ingress port, that matches an ingress port criteria for a given flow rule. If a packet matches other criteria of the flow rule then the packet may be said to “correspond” to the flow rule. In some implementations, the match can, for example, be a direct value match. In some implementations, the match can, for example, be a non-direct value match (e.g., through the use of one or more wildcards in the flow rule). It is appreciated that metadata may “correspond” to flow entities in ways not expressly described herein.

Method 130 includes counting (at block 136), with the counter of switch 104, data relating to the first data packet in accordance with the association instructions received from SDN controller 102. Counting data relating to a data packet can, for example, include counting a number of packets that trigger the counter, counting an amount of bytes of packets that trigger the counter, and/or counting other aspects of packets that trigger the counter. It is appreciated that in some implementations, counting data relating to a data packet can include counting a number of packets that trigger the counter as well as an amount of bytes of packets that trigger the counter.

As used herein, the term “trigger the counter” can, for example, refer to when a flow rule (or other suitable flow entity) is matched against a packet received by switch 104. For example, as described above, a given flow rule can, for example, contain information such as match fields to match against packets (e.g., an ingress port and specific packet header fields) as well as instructions to modify the action set or pipeline processing. As an example, a first flow rule for network switch 104 can provide that any packets received through ingress port A are to be forwarded to egress port C and a second flow rule for network switch 104 can provide that any packets received through ingress port B are to be forwarded to egress port D.

Packets can be counted in switch 104 via a suitable Network Packet Counter (NPC). The NPC can be a portion of the ASIC designed to allow for efficient and quick network packet counting, rather than general-purpose processing. The NPC can, for example, store the pattern of a flow rule and can thereafter quickly determine whether a received packet matches the pattern. Likewise, In some implementations, packets can be metered in switch 104 via a suitable Network Packet Meter (NPM) The NPM can be a portion of the ASIC designed to allow for efficient and quick network packet metering, rather than general-purpose processing. The NPM can, for example, store the pattern of a flow rule and can thereafter quickly determine whether a received packet matches the pattern.

The term “counting with the counter” as used herein can, in some implementations, refer to a simple incrementing of a counter value. However, it is appreciated that the term can further refer to any other suitable modification of a counter value, such as increasing the counter value by two units. Likewise, non-linear modifications can be made, such as for example multiplying the counter value. Moreover, it is further appreciated that modifying the counter value can include reducing the counter value and/or resetting the counter value to 0 or another value. As provided above, aspects of the data packet, such as size of the packet, beyond the number of packets can be counted. It is further appreciated that in some implementations, the NPC may count data (or another aspect) associated with matching packets and does not actually count the packets themselves. For example, in some implementations, the NPC can count a predetermined amount of data received in matching packets (e.g., 10,000 bytes of data in matching packets) before applying an action. It is appreciated that other criteria besides a number of packets, data, etc., can be counted by the NPC in certain implementations.

Method 130 includes receiving (at block 138) at switch 104 a second data packet having metadata corresponding to the second flow entity and counting (at block 140), with the counter, data relating to the second data packet in accordance with the association instructions received from SDN controller 102. Further details regarding receiving data packets having metadata corresponding to flow entities and counting data relating to received data packets is described above with respect to blocks 134 and 136.

Method 130 includes transmitting (at block 142), from switch 104 to SDN controller 102, data relating to the first and second received data packets. In some implementations, data relating to the first and second received data packets transmitted to SDN controller 102 is the data counted by the counter for the first and second received data packets. In some implementations, the transmitted data can be processed or otherwise modified before transmission. For example, in some implementations, the data relating to the first and second received data packets transmitted to SDN controller 102 is created by processing data counted by the counter for the first and second received data packets for use with an SDN application.

For example, the SDN application can apply one or more actions based on a determination that the data relating to the first and second received data packets satisfies a predetermined criteria. For illustration, an example will be provided in which data relating to the first and second data packets is in the form of a counter value, however as described herein, it is appreciated other forms of data can be transmitted. In some implementations, the predetermined criteria is satisfied when the counter value is less than a threshold value and the predetermined criteria is not satisfied when the value for the counter is equal to or exceeds a threshold value. In some implementations, the predetermined criteria is satisfied when the value for the counter is less or equal to a threshold value and the predetermined criteria is not satisfied when the value for the counter exceeds a threshold value. Such a threshold value can, for example, correspond to a specific number of packets received by network switch 104 that match multiple flow entries, such as for example five packets. It is appreciated that more complicated criteria can be applied. For example, in some implementations the criteria is satisfied only if the value for the counter is less than a threshold value and another condition is satisfied, such as a certain amount of time has elapsed since a starting time. It is appreciated that other types of conditions and criteria may be used. For example, in some implementations, the condition can be in the form of an amount of data, such as a given number of bytes of data from matching packets. For example, criteria may be satisfied when 10,000 bytes of data from matching packets is received by the network switch. In such an implementation, if each matching packet has a size of 1,000 bytes, then the criteria can be satisfied after the switch receives 10 matching packets. As described in further detail below, the criteria can be determined by SDN controller 102 by itself or in combination with network switch 104 or another entity, such as a network administrator.

Although the flowchart of FIG. 2 shows a specific order of performance, it is appreciated that this order may be rearranged into another suitable order, may be executed concurrently or with partial concurrence, or a combination thereof. Likewise, suitable additional and/or comparable steps may be added to method 130 or other methods described herein in order to achieve the same or comparable functionality. In some implementations, one or more steps are omitted. For example, in some implementations, block 132 of receiving assignment instructions from SDN controller 102 can be omitted from method 130. It is appreciated that blocks corresponding to additional or alternative functionality of other implementations described herein can be incorporated in method 130. For example, blocks corresponding to the functionality of various aspects of switch 104 otherwise described herein can be incorporated in method 130 even if such functionality is not explicitly characterized herein as a block in a method.

A specific example implementation will now be described. It is appreciated that this implementation may include certain aspects of other implementations described herein (and vice-versa), but it is not intended to be limiting towards other implementations described herein. An example implementation of method 130 can incorporate a programmable switch ASIC, such as ASIC 108, with an SDN pipeline and a counter block with a counter table that provides multiple packet/byte counters. SDN managing software running in the CPU of the ASIC can reserve one of the available counters and create a pointer to this counter. When a flow table (or other suitable flow entity) is created in the hardware of the ASIC, the flow table is associated with a pointer to the counter that was previously allocated, in this way, when a packet is redirected to the flow table or the flow entry, the programmable switch ASIC will fetch the pointer to the counter and increment the counter by one (if the counter is configured as a packet counter), by the packet size (if the counter is configured as a byte counter), or another suitable value. This example can therefore provide a counter entity that is associated with multiple flow tables or multiple flow entries.

FIG. 3 is a diagram of a network switch 104 in accordance with the present disclosure. As described in further detail below, network switch 104 includes a switch processing resource 144, a switch memory resource 146 that stores machine-readable instructions 148 and 150, an ASIC 108 including an ASIC processing resource 152 and an ASIC memory resource 154 that stores machine-readable instructions 156 and 158. For illustration, the description of network switch 104 of FIG. 3 makes reference to various aspects of method 130 of FIG. 2 (such as the ASIC identified above with respect to FIG. 1). Indeed, for consistency, the same reference number for the network switch of FIG. 1 is used for the network switch of FIG. 3. However it is appreciated that network switch 104 of FIG. 3 can include additional, alternative, or fewer aspects, functionality, etc., than the implementation described with respect to method 130 as well as the network switch of FIG. 1 and is not intended to be limited by the related disclosure thereof.

The term “ASIC” as used herein can, for example, include related technologies such as application-specific field-programmable gate arrays (FPGAs), which can, for example contain an array of programmable logic blocks, and a hierarchy of reconfigurable interconnects that allow the blocks to be wired together. Suitable ASICs for use with the present disclosure can, for example, allow for logic blocks to be configured to perform complex combinational functions as well as simple logic gates like AND and XOR. Suitable ASICs for use with the present disclosure can, for example, also include memory elements, which may be simple flip-flops or more complete blocks of memory. In some implementations, ASIC 108 is configurable by SDN controller 102.

Instructions 148 stored on switch memory resource 146 are, when executed by switch processing resource 144, to cause switch processing resource 144 to process a received data packet and instructions 150 are, when executed by switch processing resource 144, to cause switch processing resource 144 to forward the received data packets to another device in a network. Instructions 148 and 150 can, for example, rely on flow rules stored on switch 104 (or otherwise accessible by the switch) for forwarding or otherwise handling traffic. Instructions 148 and 150 can incorporate one or more aspects of blocks of method 130 or another suitable aspect of other implementations described herein (and vice versa).

Instructions 156 stored on ASIC memory resource 154 are, when executed by ASIC processing resource 152, to cause ASIC processing resource 152 to manage a plurality of flow entities stored on the memory resource. Instructions 156 can incorporate one or more aspects of blocks of method 130 or another suitable aspect of other implementations described herein (and vice versa). For example instructions 156 can cause ASIC processing resource 152 to receive, from SDN controller 102, instructions to associate a first flow entity with a counter of ASIC 108 and to associate a second flow entity with the same counter and can cause ASIC processing resource 152 to further receive a first data packet having metadata corresponding to the first flow entity.

Instructions 158 stored on ASIC memory resource 154 are, when executed by ASIC processing resource 152, to cause ASIC processing resource 152 to count, with a single counter, data relating to data packets that match multiple flow entities of the plurality of flow entities. Instructions 158 can incorporate one or more aspects of blocks of method 130 or another suitable aspect of other implementations described herein (and vice versa).

Each processing resource of network switch 104 can, for example, be in the form of a central processing unit (CPU), a semiconductor-based microprocessor, a digital signal processor (DSP) such as a digital image processing unit, other hardware devices or processing elements suitable to retrieve and execute instructions stored in a memory resource, or suitable combinations thereof. Each processing resource can, for example, include single or multiple cores on a chip, multiple cores across multiple chips, multiple cores across multiple devices, or suitable combinations thereof. Each processing resource can be functional to fetch, decode, and execute instructions as described herein. As an alternative or in addition to retrieving and executing instructions, each processing resource can, for example, include at least one integrated circuit (IC), other control logic, other electronic circuits, or suitable combination thereof that include a number of electronic components for performing the functionality of instructions stored on a memory resource. The term “logic” can, in some implementations, be an alternative or additional processing resource to perform a particular action and/or function, etc., described herein, which includes hardware, e.g., various forms of transistor logic, application specific integrated circuits (ASICs), etc., as opposed to machine executable instructions, e.g., software firmware, etc., stored in memory and executable by a processor. Each processing resource can, for example, be implemented across multiple processing units and instructions may be implemented by different processing units in different areas of network switch 104.

Each memory resource of network switch 104 can, for example, be in the form of a non-transitory machine-readable storage medium, such as a suitable electronic, magnetic, optical, or other physical storage apparatus to contain or store information such as machine-readable instructions 148, 150, 156, and 158. Such instructions can be operative to perform one or more functions described herein, such as those described herein with respect to method 130 or other methods described herein. Each memory resource can, for example, be housed within the same housing as a respective processing resource for network switch 104, such as within a computing tower case for network switch 104. In some implementations, each memory resource and processing resource are housed in different housings. As used herein, the term “machine-readable storage medium” can, for example, include Random Access Memory (RAM), flash memory, a storage drive (e.g., a hard disk), any type of storage disc (e.g., a Compact Disc Read Only Memory (CD-ROM), any other type of compact disc, a DVD, etc.), and the like, or a combination thereof. In some implementations, each memory resource can correspond to a memory including a main memory, such as a Random Access Memory (RAM), where software may reside during runtime, and a secondary memory. The secondary memory can, for example, include a nonvolatile memory where a copy of machine-readable instructions are stored. It is appreciated that both machine-readable instructions as well as related data can be stored on memory mediums and that multiple mediums can be treated as a single medium for purposes of description.

ASIC processing 152 and ASIC memory resource 154 can be in communication via a communication link 160. Likewise, switch processing resource 144 can be in communication with ASIC 108 and switch memory resource 146 via respective communication links 162 and 164. These links can, for example, be in the form of local communication links such as an electronic bus internal to a machine (e.g., a computing device). Other suitable forms of communication links can be provided.

In some implementations, one or more aspects of network switch 104 and SDN controller 102 can be in the form of functional modules that can, for example, be operative to execute one or more processes of instructions 148, 150, 156, or 158 or other functions described herein relating to other implementations of the disclosure. As used herein, the term “module” refers to a combination of hardware (e.g., a processor such as an integrated circuit or other circuitry) and software (e.g., machine- or processor-executable instructions, commands, or code such as firmware, programming, or object code). A combination of hardware and software can include hardware only (i.e., a hardware element with no software elements), software hosted at hardware (e.g., software that is stored at a memory and executed or interpreted at a processor), or hardware and software hosted at hardware. It is further appreciated that the term “module” is additionally intended to refer to one or more modules or a combination of modules. Each module of a network switch 104 can, for example, include one or more machine-readable storage mediums and one or more computer processors.

In view of the above, it is appreciated that the various instructions of network switch 104 described above can correspond to separate and/or combined functional modules. For example, instructions 156 can correspond to a “flow entity manager module” to manage the plurality of flow entities stored on the memory resource as described above, instructions 158 can correspond to a “counter module” to count data relating to data packets that match multiple flow entities of the plurality of flow entities as described above. It is further appreciated that a given module can be used for multiple functions. As but one example, in some implementations, a single module can be used to both manage flow entities (e.g., corresponding to the functionality of instructions 156) as well as to count data (e.g., corresponding to the functionality of instructions 158). Likewise, SDN controller 102 can include various modules corresponding to the various functions performed by SDN controller 102, such as a module to prepare and send to switch 104 instructions to associate a first flow entity with a counter of programmable ASIC 108 and to associate a second flow entity with the same counter.

One or more nodes within SDN 100 (e.g., SDN controller 102, network switch 104, etc.) can further include a suitable communication module to allow networked communication between SDN controller 102, network switch 104, and/or other elements of SDN 100. Such a communication module can, for example, include a network interface controller having an Ethernet port and/or a Fibre Channel port. In some implementations, such a communication module can include wired or wireless communication interface, and can, in some implementations, provide for virtual network ports. In some implementations, such a communication module includes hardware in the form of a hard drive, related firmware, and other software for allowing the hard drive to operatively communicate with other hardware of SDN controller 102, network switch 104, or other network equipment. The communication module can, for example, include machine-readable instructions for use with communication the communication module, such as firmware for implementing physical or virtual network ports.

FIG. 4 illustrates a machine-readable storage medium 166 including various instructions that can be executed by a computer processor or other processing resource. In some implementations, medium 166 can be housed within a network switch, such as a network switch 104, or on another computing device within SDN 100 or in local or remote wired or wireless data communication with SDN 100.

For illustration, the description of machine-readable storage medium 166 provided herein makes reference to various aspects of network switch 104 and other implementations of the disclosure (e.g., method 130). Although one or more aspects of network switch 104 (as well as instructions such as instructions 148, 150, 156, and 158) can be applied or otherwise incorporated with medium 166, it is appreciated that in some implementations, medium 184 may be stored or housed separately from such a system. For example, in some implementations, medium 166 can be in the form of Random Access Memory (RAM), flash memory, a storage drive (e.g., a hard disk), any type of storage disc (e.g., a Compact Disc Read Only Memory (CD-ROM), any other type of compact disc, a DVD, etc.), and the like, or a combination thereof.

Medium 166 includes machine-readable instructions 168 stored thereon to cause a processing resource to match a first received data packet with a first flow entity. Instructions 168 can, for example, incorporate one or more aspects of block 134 or block 136 (or another suitable block or blocks) of method 130 or another suitable aspect of other implementations described herein (and vice versa).

Medium 166 includes machine-readable instructions 170 stored thereon to cause the processing resource to send a first set of data relating to the first received data packet to a counter of ASIC 108. Instructions 170 can, for example, incorporate one or more aspects of block 134 or block 136 (or another suitable block or blocks) of method 130 or another suitable aspect of other implementations described herein (and vice versa).

Medium 166 includes machine-readable instructions 172 stored thereon to cause the processing resource to match a second received data packet with a second flow entity. Instructions 172 can, for example, incorporate one or more aspects of block 138 or block 140 (or another suitable block or blocks) of method 130 or another suitable aspect of other implementations described herein (and vice versa).

Medium 166 includes machine-readable instructions 174 stored thereon to cause the processing resource to send a second set of data relating to the second received data packet to the counter. Instructions 174 can, for example, incorporate one or more aspects of block 138 or block 140 (or another suitable block or blocks) of method 130 or another suitable aspect of other implementations described herein (and vice versa).

Medium 166 includes machine-readable instructions 176 stored thereon to cause the processing resource to transmit, to SDN controller 102, data relating to the first and second sets of data. Instructions 176 can, for example, incorporate one or more aspects of block 142 (or another suitable block or blocks) of method 130 or another suitable aspect of other implementations described herein (and vice versa).

While certain implementations have been shown and described above, various changes in form and details may be made. For example, some features that have been described in relation to one implementation and/or process can be related to other implementations. In other words, processes, features, components, and/or properties described in relation to one implementation can be useful in other implementations. Furthermore, it should be appreciated that the systems and methods described herein can include various combinations and/or sub-combinations of the components and/or features of the different implementations described. Thus, features described with reference to one or more implementations can be combined with other implementations described herein.

As used herein, “logic” is an alternative or additional processing resource to perform a particular action and/or function, etc., described herein, which includes hardware, e.g., various forms of transistor logic, application specific integrated circuits (ASICs), etc., as opposed to machine executable instructions, e.g., software firmware, etc., stored in memory and executable by a processor. Further, as used herein, “a” or “a number of” something can refer to one or more such things. For example, “a number of widgets” can refer to one or more widgets. Also, as used herein, “a plurality of” something can refer to more than one of such things.

What is claimed is:

1. A method comprising:
receiving, from a Software-Defined Networking (SDN) controller, instructions to associate a first flow entity with a counter of a programmable Application-Specific Integrated Circuit (ASIC) and to associate a second flow entity with the same counter;
receiving a first data packet having metadata corresponding to the first flow entity;
counting, with the counter, data relating to the first data packet in accordance with the association instructions received from the SDN controller;
receiving a second data packet having metadata corresponding to the second flow entity;
counting, with the counter, data relating to the second data packet in accordance with the association instructions received from the SDN controller; and
transmitting, to the SDN controller, data relating to the first and second received data packets.

2. The method of claim 1, wherein the first flow entity is a first flow table and the second flow entity is a second flow table.

3. The method of claim 1, wherein the first flow entity is a first flow entry and the second flow entity is a second flow entry.

4. The method of claim 1, wherein the first flow entity is a first flow queue and the second flow entity is a second flow queue.

5. The method of claim 1, wherein the instructions to associate a first flow entity with a counter and to associate a second flow entity with the counter includes:
reserving a counter of the ASIC; and
creating a pointer to the counter such that when a packet matches a flow entity, the counter is triggered via the pointer.

6. The method of claim 1, wherein counting data relating to a data packet includes counting a number of packets that trigger the counter.

7. The method of claim 1, wherein counting data relating to a data packet includes counting an amount of bytes of packets that trigger the counter.

8. The method of claim 1, wherein counting data relating to a data packet includes counting a number of packets that trigger the counter as well as an amount of bytes of packets that trigger the counter.

9. The method of claim 1, wherein the counter is in the form of a meter to obtain a rate relating to received data packets.

10. The method of claim 1, wherein the data relating to the first and second received data packets transmitted to the SDN controller is the data counted by the counter for the first and second received data packets.

11. The method of claim 1, wherein the data relating to the first and second received data packets transmitted to the SDN controller is created by processing data counted by the counter for the first and second received data packets for use with an SDN application.

12. A non-transitory machine readable storage medium having stored thereon machine readable instructions to cause a computer processor to:
match a first received data packet with a first flow entity;
send a first set of data relating to the first received data packet to a counter of a programmable Application-Specific Integrated Circuit (ASIC);
match a second received data packet with a second flow entity;
send a second set of data relating to the second received data packet to the counter; and
transmit, to a Software-Defined Network (SDN) controller, data relating to the first and second sets of data.

13. The medium of claim 12, wherein the medium is housed within a housing of an SDN-capable network switch.

14. A network switch comprising:
a switch processing resource;
a switch memory resource, wherein the switch memory resource includes machine readable instructions to:
process a received data packet; and
forward the received data packets to another device in a network; and
a programmable Application-Specific Integrated Circuit (ASIC), the ASIC including:
an ASIC processing resource and
an ASIC memory resource, wherein the ASIC memory resource includes machine readable instructions to:
manage a plurality of flow entities stored on the memory resource; and
count, with a single counter, data relating to data packets that match multiple flow entities of the plurality of flow entities.

15. The network switch of claim 14, wherein the programmable ASIC is configurable by a Software-Defined Network (SDN) controller in communication with the switch.
